(19) United States
(12) Patent Application Publication
(10) Pub. No.: US 2005/0028680 A1
(43) Pub. Date: Feb. 10, 2005

(54) Biosolids pasteurization systems and methods

(75) Inventors: James E. Thompson, The Woodlands, TX (US); James E. Helmick, Spring, TX (US)

Correspondence Address: Jeffrey L. Wendt;The Wendt Group, 34 Driftoak Circle, The Woodlands, TX, 77381, US

(73) Assignee: Ashbrook Corporation, Houston, TX (US)

(21) Appl. No.: 10/635,961

(22) Filed: Aug. 7, 2003

(51) Int. Cl. A23C 3/04

(52) U.S. Cl. 99/455

(57) ABSTRACT

Systems and processes are presented which reduce space requirements for pasteurization equipment. The systems include an enclosure defining a heating chamber, and a liquid flow conduit positioned within the heating chamber, the conduit having an inlet and an outlet and defining a flow path for a slurry to be pasteurized. The slurry is heated via indirect contact heat transfer from ambient temperature to a minimum temperature after the slurry is introduced into the flow conduit. The means for heating is positioned inside the heating chamber.

### BACKGROUND OF THE INVENTION

1. Brief Description of the Invention

The present invention generally concerns treatment of biosolids in a substantially aqueous stream. More particularly, the present invention pertains to systems and methods to remove or reduce pathogens in such fluids through the use of heat, time, and certain process conditions.

2. Related Art

As described in U.S Pat. No. 6,447,683, application of treated wastewater sludge (biosolids) to farmlands and other land where humans might be expected to have substantial contact is controversial because the biosolids therein potentially contain human pathogens. There are generally two classes of biosolids recognized in the United States Environmental Protection Agency's (EPA) regulations: Class B pathogen reduction standards, as set forth in 40 CFR 503, which require a fecal coliform level of less than two million most-probable-number (MPN) per gram of total solids, and Class A pathogen standards per 40 CFR 503. EPA's Class A pathogen standards requirements are met in biosolids when fecal coliform densities are less than 1,000 MPN per gram total solids; or when Salmonella densities are less than 3 MPN per four grams total solids. Additionally, enteric virus must be less than 1 plaque-forming unit per four grams of total solids, and helminth ova is less than one viable helminth ova per four grams of total solids. Anaerobic digestion has been one of the most widely used processes for the stabilization of primary and secondary sludges produced at municipal wastewater treatment facilities. The majority of applications of anaerobic digestion to wastewater sludges have been in the mesophilic temperature range, from 35 C to 40 C (95 F to 104 F). Anaerobic sludge digestion in the thermophilic temperature range from 45 C to 65 C (113 F to 149 F) has been practiced to only a limited extent. The limited use of anaerobic digestion at temperatures above the mesophilic range is due (according to the '683 patentees) to higher energy requirements to obtain the higher thermophilic temperature, poor process stability, increased odor, and lower quality supernatant (filtrate/centrate). The advantages of thermophilic anaerobic digestion over mesophilic anaerobic digestion have accrued from increased stabilization and methane production rates, and from improvements in sludge dewatering properties. Since the advent of the 40 CFR Part 503 Regulations, more studies have focused on the destruction of pathogenic organisms. According to he 683 patentees, thermophilic anaerobic digestion has an advantage of improving pathogen destruction, and has the potential to meet the pathogen quality requirements of EPA's Class A biosolids. While the economic disadvantages of thermophilic anaerobic digestion has outweighed the advantages of the process, the implementation of 40 CFR Part 503 and the use of a two-stage digestion system, having a thermophilic or mesophilic first-stage and a mesophilic or thermophilic second-stage, may negate the economic disadvantage. The 683 patent describes a method of treating a waste stream comprising: feeding a waste stream into a thermophilic anaerobic reactor maintained in a thermophilic temperature regime of between about 50 C and 62 C, for a hydraulic residence time (HRT) of less than or equal to 48 hours; drawing a portion of the contents of the thermophilic reactor and feeding the drawn contents into a mesophilic anaerobic reactor which is maintained in a mesophilic temperature regime of between about 28 C to 38 C for a HRT of at least thirteen days; and replacing the volume of the drawn contents from the thermophilic reactor by feeding the thermophilic reactor with a volume of waste from the waste stream.

U.S. Pat. No. 6,103,191 describes a continuous flow sludge pasteurization system, comprising: a liquid flow chamber having an inlet and an outlet and defining a continuous liquid flow path for maintaining a continuous flow of a slurry from said inlet toward said outlet at a predetermined rate for establishing a minimum period of residence time of the slurry within said flow chamber sufficient to kill all pathogens in said slurry at a predetermined minimum temperature of between about 145 and 160 degrees F.; means for introducing a continuous flow of a liquid slurry of sludge into said liquid flow chamber and for establishing and maintaining a continuous flow of a liquid slurry through said liquid flow chamber from said inlet to said outlet at said predetermined rate; and means for introducing heat into a liquid slurry being introduced into said liquid flow chamber for heating said continuous flow of slurry to said predetermined minimum temperature. U.S Pat. No. 5,888,453 describes a continuous flow sludge pasteurization system, comprising: a liquid flow system including a reservoir having an inlet and an outlet and means for establishing and maintaining a continuous flow of a liquid slurry into said inlet and from said outlet; a heat exchanger at said inlet for introducing heat into said slurry; a source of heat for introducing heat into said heat exchanger for heating said continuous flow of slurry to a predetermined minimum temperature; a rotating propeller positioned between said inlet and said outlet for acting against the continuous flow of slurry toward said outlet for maintaining said slurry in said liquid flow system at said predetermined temperature for a minimum period of about thirty minutes sufficient to kill all pathogens in said slurry; and dewatering means after said outlet for removing water from said slurry.

U.S. Pat. Nos. 5,554,279 and 5,618,442 describe a process and apparatus for treating sewage sludge, the process comprising the steps of: (a) providing sewage sludge; (b) mixing the sludge with at least one alkaline additive proportionate to the sludge, such that a reaction caused thereby increases the temperature of the mixture to a minimum temperature and increases the pH of the mixture to a minimum level to reduce pathogens in said mixture; (c) providing a pasteurization chamber having at least one inlet opening and at least one discharge opening; (d) delivering the sludge and alkaline additive mixture to the inlet opening of the pasteurization chamber; (e) continuously conveying substantially every particle of the mixture through the pasteurization chamber, without any substantial agitation of the mixture such that the mixture does not become more watery, wherein said mixture is substantially enclosed in the pasteurization chamber for a dwell time such that harmful pathogens in said mixture are substantially destroyed during said conveying; and (f) discharging the mixture from the discharge opening of the pasteurization chamber.

Other references include U.S. Pat. Nos. 5,385,673; 5,429,750; 5,525,228; 5,603,842; 5,624,565; 5,650,070; 5,681,481; 5,716,518; 5,746,919; 5,783,073; 5,851,404; 5,900,150; 5,916,448; 6,113,789; 6,254,775; 6,291,232; WO 02/072485; and 40 CFR 503.

Presently known processes for pasteurization, however, tend to be batch processes and are expensive to construct and operate. Pasteurization, however, can ultimately reduce some cost of disposal by reducing the expense of paying commercial disposal companies for disposal of the sludge. Pasteurization can turn the sludge into a resource making it sufficiently desirable that much of the cost can be recovered. Known biosolids pasteurization systems typically employ a heater or heat exchanger unit to heat the biosolids, followed by a separate reactor, typically a plug flow pipeline reactor. However, pasteurization costs must be sufficiently low to make the whole operation economical. It is therefore desirable that inexpensive and cost-effective pasteurization systems and processes be available.

### SUMMARY OF THE INVENTION

In accordance with the present invention, systems and processes are described that employ an enclosure for defining a heating chamber, and one or more biosolids slurry flow paths within the heating chamber, in order to provide the residence time and temperature required to form Class A biosolids. The systems essentially combine the heating function of the heater/heat exchanger unit of known systems with the plug flow reactor of known systems, thus providing an opportunity either for space savings, or increased biosolids treating capacity for an equivalent size system known in the art.

A first aspect of the invention is a pasteurization system comprising:

a) an enclosure defining a heating chamber;

b) a liquid flow conduit positioned within the heating chamber, the conduit having an inlet and an outlet and defining a flow path for a slurry to be pasteurized while flowing from the inlet toward the outlet at a predetermined rate for establishing a minimum period of residence time of the slurry within the flow conduit sufficient to kill all pathogens in the slurry while the slurry is heated from ambient temperature to a predetermined minimum temperature of between about 145 and 160 F while the slurry traverses the conduit; and

c) means for heating, via indirect contact heat transfer, the slurry from ambient temperature to the minimum temperature after the slurry is introduced into the flow conduit, the means for heating positioned inside the heating chamber.

Preferred systems of the invention include systems wherein the means for heating comprises at least one header having a plurality of means for emitting a heat transfer fluid into the heating chamber and to contact the heat transfer fluid with the conduit in a plurality of locations. Other preferred systems are those wherein the conduit comprises a serpentine conduit comprising a plurality of substantially parallel pathways in the heating chamber. Particularly preferred systems are those wherein the heat transfer fluid is selected from the group consisting of water, steam, or combinations thereof, in particular systems wherein the heat transfer fluid is water adapted to have a temperature exiting the header ranging from about 170 F to about 212 F. Other preferred systems include an inlet water transfer means and an exit water transfer means. Preferably, the heat transfer fluid is a liquid, and the enclosure comprises a sump for spent heat transfer liquid, wherein the system comprises inlet transfer means adapted to deliver fresh heat transfer fluid and exit transfer means adapted to remove spent heat transfer fluid. Yet other preferred systems are those wherein at least a first leg of the serpentine conduit is adapted to traverse through spent heat transfer fluid collected in a sump, the sump comprising a lower portion of the enclosure. Yet other preferred embodiments are those wherein the liquid flow conduit comprises a plurality of conduits, each of the plurality of conduits attached at a first end to an inlet header and at a second end to an exit header. In these embodiments, it is preferred that the enclosure includes a sump comprising a non-horizontal bottom. In yet other preferred embodiments the system further comprises one or more a fuel burners to provide auxiliary or emergency heat.

A second aspect of the invention is a pasteurization process (preferably continuous), the process comprising the steps of:

a) providing an enclosure defining a heating chamber, and providing a flow conduit positioned in the heating chamber, the flow conduit having an inlet and an outlet;

b) introducing a flow of a liquid slurry into the conduit at the inlet;

c) introducing into the heating chamber a heat transfer fluid at a first temperature, said first temperature being not less than 160 F;

d) heating the slurry via indirect contact heat transfer from ambient temperature to a predetermined minimum temperature of from about 145 F to about 160 F via indirect contact with the heat transfer fluid while the slurry traverses through the conduit; and

e) maintaining the flow of slurry in the conduit at the predetermined temperature for a minimum period of about thirty minutes sufficient to kill substantially all pathogens in the slurry while maintaining a flow of the slurry from the outlet.

Preferred processes of the invention are those wherein the step of introducing a heat transfer fluid comprises transferring a heat transfer fluid into and out of a sump; processes wherein the step of introducing a heat transfer fluid comprises providing one or more heat transfer fluid headers in the heating chamber, the headers having a plurality of means for dispensing the heat transfer fluid in the heating chamber. Other preferred processes include those including introducing heated combustion effluent gases into the heating chamber via combustion of a fuel in one or more combustion burners attached to the enclosure.

In order to carry out the processes of the invention, several apparatus for biosolids pasteurization known in the art are employed in combination. What is considered unique and patentable is the combination into one unit of the heating and reactor unit operations.

Further aspects of the inventive processes will become apparent from the brief description of the drawings and preferred embodiments that follow, which in no way limit the appended claims.

### BRIEF DESCRIPTION OF THE DRAWINGS

FIG. 1 is a schematic process flow diagram of a prior art system and process known in the art under the trade designation ECO-THERM™, available from Ashbrook Corporation, Houston, Tex., the assignee of the present application;

FIG. 2 is a schematic process flow diagram of a biosolids treatment facility including a first system and process embodiment in accordance with the invention;

FIG. 3 is a schematic process flow diagram of a second system and process in accordance with the present invention;

FIG. 4 is a schematic process flow diagram of a third system and process in accordance with the present invention; and

FIG. 5 is a schematic process flow diagram of a fourth system and process in accordance with the present invention.

### DESCRIPTION OF PREFERRED EMBODIMENTS

This invention presents embodiments of systems and processes to pasteurize sludge, and in some instances, to meet the EPA's Class A pathogen requirements, as set forth in 40 CFR Part 503, the requirements of which have been previously identified. As used herein, a mesophilic temperature range includes temperatures ranging from about 35 C. to about 40 C., while a thermophilic temperature range includes temperatures ranging from about 40 C to about 70 C. Temperatures above 70 C are in a range that will pasteurize an organic material in thirty minutes per 40 CFR 503, Appendix B.7.

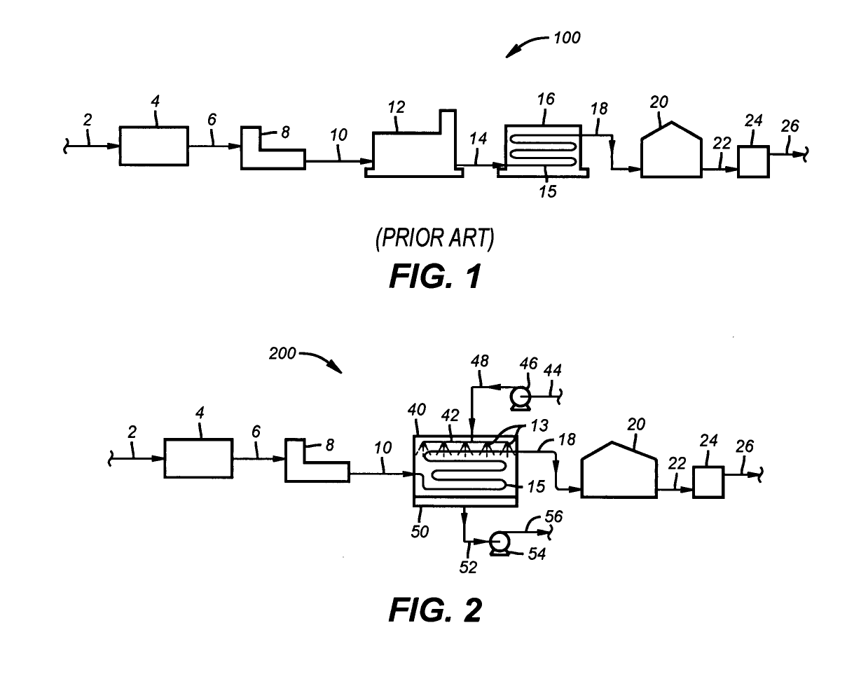

Turning now to FIG. 1, illustrated at 100 is a prior art system and process known under the trade designation ECO-THERM™, available from Ashbrook Corporation, Houston, Tex., for producing Class A biosolids via pasteurization. A slurry from sludge holding enters the process at 2 and flows to a thickening station 4, preferably a gravity belt thickener. A thickened biosolids traverses a conduit 6 to a positive displacement pump 8, which in turn transfers the thickened biosolids through a conduit 10 to a heater 12. Heater 12 is typically a steam-heated tube and shell or spiral heat exchanger, or gas fired or other fuel fired furnace having a plurality of tubes through which the biosolids flow. Biosolids absorb heat from the heater 12. In the prior art process illustrated in FIG. 1, the thickened biosolids are heated to a temperature sufficient to place the biosolids in the thermophylic temperature regime, and then traverse through a conduit 14 to a plug flow reactor 16. Plug flow reactor 16, in its most general version comprises a serpentine tube 15 through which the previously heated, thickened biosolids flow, affording residence time, typically referred to as a hydraulic residence time or HRT, sufficient to pasteurize the biosolids, in other words, cause destruction of substantially all pathogens in the biosolids. Biosolids exit plug flow reactor 16 through a conduit 18 and at this point are termed pasteurized biosolids. The pasteurized biosolids continue their path onto an anaerobic digester 20, carrying heat from the pasteurization stage sufficient to provide a mesophylic anaerobic biological reaction. The HRT for the digester ranges anywhere from 10 days to 40 days, more preferably from 20 day to 30 days. The biosolids then traverse a conduit 22 into a belt filter press or other thickening means, 24, at which point they are termed Class A biosolid products, and traverse a conduit 26 to their final destination.

Referring now to FIG. 2, components having the same function as in the prior art process of FIG. 1 have like numerals. Therefore, conduits 2, 6, 10, 15, 18, 22, and 26 remain as in FIG. 1, as do thickening station, preferably a gravity belt thickener 4, positive displacement pump 8, anaerobic digester 20, and thickening means 24, preferably a belt filter press. As illustrated in FIG. 2, there is no longer a separate heater 12 and plug flow reactor 16. This dramatically reduces the space, commonly referred to as the footprint, of the system of the invention when compared to that of the previously known systems as illustrated in FIG. 1. Thickened biosolids traverse conduit 10 directly into a unit 40, termed herein a pasteurization unit, which comprises in this embodiment a header 42 having a plurality of ports 43 or other means for delivering a heat transfer fluid to an interior chamber of pasteurization unit 40. Means 43 preferably are spray nozzles, which spray heated water or other heat transfer fluid onto serpentine conduit 15 traversing through pasteurization unit 40. Header 42 is supplied by conduits 44 and 48 and transfer means 46. Located near the bottom of pasteurization unit 40, is a sump 50 that collects the water that has been sprayed on conduit 15. This water is collected in a conduit 52 and is transferred via a second transfer means 54 and conduit 56, preferably back to a source of heat, such as a boiler or other heat exchanger. The temperature of the fluid traversing conduits 44 and 48 and transfer means 46 and on into header 42, if a liquid, preferably ranges from about 170 to about 200° F., more preferably from about 180 to about 200° F. These temperatures will be dependent on the heat transfer fluid available. If steam or another fluid is used as the heat transfer fluid, the temperatures will be higher. Depending on the HRT of the biosolids traversing pasteurization unit 40 through the conduit 15, materials of construction, heat transfer coefficients, scale or other buildup in conduit 15 or outside of conduit 15, the temperature of the pasteurized biosolids exiting unit 40 through conduit 18 will range from about 150 to about 170° F. In any case the HRT and temperature will be sufficient to significantly reduce pathogens traversing to digester 20.

As illustrated in FIG. 2, the elimination of separate heating unit and plug flow reactor as in prior art FIG. 1, and the formation of one unit, a pasteurization unit 40, significantly reduces space requirements. The reduction in space requirement may be anywhere from 5% to 30%, depending on the amount of biosolids being processed by pasteurization unit 40, which will influence not only the size of the pasteurization unit 40, but also the size of transfer means 46 and 54. The pasteurized biosolids traversing conduit 18 pass to digester 20, where a mesophilic temperature regime is obtained (a temperature ranging from about 80 to about 100° F.) and a pH ranging from about 7.0 to 8.0. This is anaerobic digestion. As in the embodiment of FIG. 1, the HRT in digester 20 preferably ranges from about 10 to about 40 days, more preferably from about 20 to 30 days. Longer periods of up to 60 days may be required for digester tanks operating at lower temperatures. A portion or all of produced digester gas (primarily methane) may be used to burn as fuel in a boiler to create heated water or other heat transfer fluid for use in the pasteurization unit. This digester gas may also be used in the embodiment 400 discussed in FIG. 4 as a fuel source.

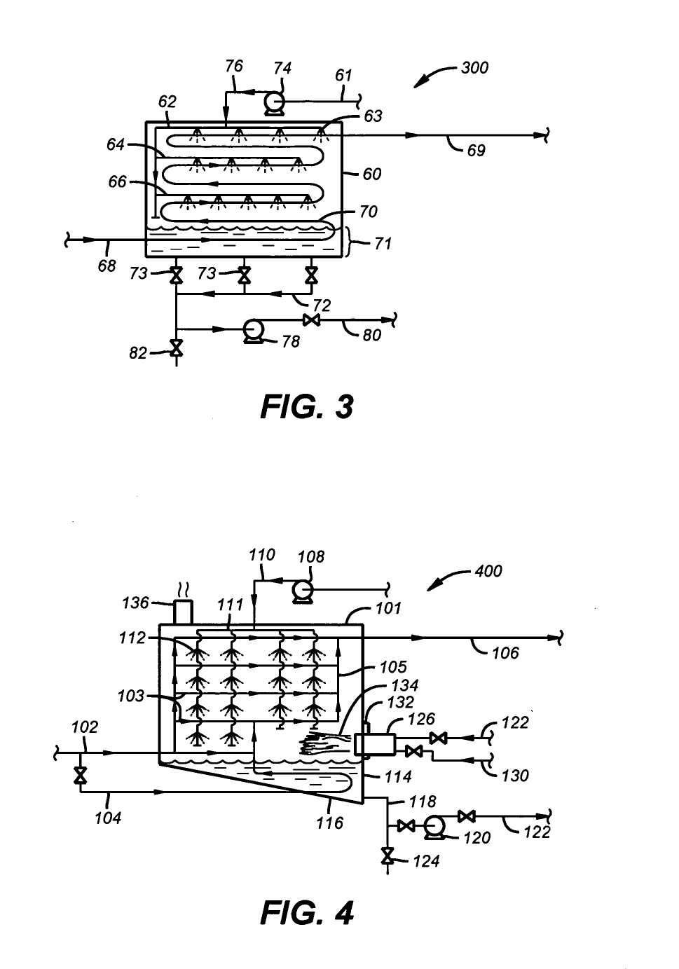

FIG. 3 illustrates an embodiment 300 of a pasteurization unit of the invention. Pasteurization unit 60 includes a heat transfer fluid (preferably warm water) header 62, which preferably has a plurality of branches 64 and 66 as illustrated in FIG. 3. A plurality of ports 63 or spray heads are depicted on each branch 62, 64 and 66, which direct heat transfer fluid onto serpentine conduit 68 through which traverses the biosolids slurry. In this preferred embodiment 300, a water level, indicated at 70 is maintained in sump 71 in the bottom of pasteurization unit 60. Heated, pasteurized biosolids exit through conduit 69. Various drain conduits 73 are collected in a header 72 from sump 71. Heat transfer fluid is supplied via a conduit 61, conduit 76 which connects to header 62, and transfer means 74. Header 72 collects the used heat transfer fluid that has collected in sump 71 and, via a transfer mean 78 and conduit 80, the used heat transfer fluid is returned to a heating source, such as a boiler or other heating means. An optional drain connection and valve 82 are provided for emergency drain out of sump 71.

Turning now to FIG. 4, FIG. 4 represents schematically another system and method of the invention. In the embodiment illustrated at 400, a pasteurization unit 101 is fed biosolids via a conduit 102, which preferably splits into a plurality of headers 103, which are recombined in a header 105. Heated biosolids exit through an exit conduit 106. An optional conduit 104 is provided which allows some or all biosolids entering pasteurization unit 101 to traverse through a sump area 114, thus taking advantage of some of the heat in the spent heat transfer fluid that has collected in sump 114. Transfer means 108 and conduit 110 connect to a series of headers 111 placed strategically within pasteurization unit 101. A plurality of ports or spray nozzles 112 are provided on headers 111 to provide a spray of warm water onto biosolid conduits 103, thus transferring heat from the heated water to the biosolids. In this preferred embodiment, a sloped sump is provided by a non-horizontal bottom element 116, which allows drawing off of the used water via a conduit 118, transfer means 120, and another conduit 122. An optional drain valve 124 is also provided.

Embodiment 400 of FIG. 4 also preferably includes a fuel burner 126, which may actually comprise more than one burner if so desired. Fuel enters burner 126 through a conduit 128 and a primary oxidant enters through a conduit 130. Preferred fuels include natural gas and digester gas or a combination thereof, while primary oxidant is preferably oxygen, oxygen enriched air, or air. A secondary oxidant inlet is provided as indicated at 132, which is preferably air. Burner 126 produces a flame 134 which serves two purposes, heating the interior space of pasteurization unit 101 and also lending heat to some of the spent heat transfer fluid collected in sump 114. Exhaust gases from pasteurization unit 101 exit through a stack 136.

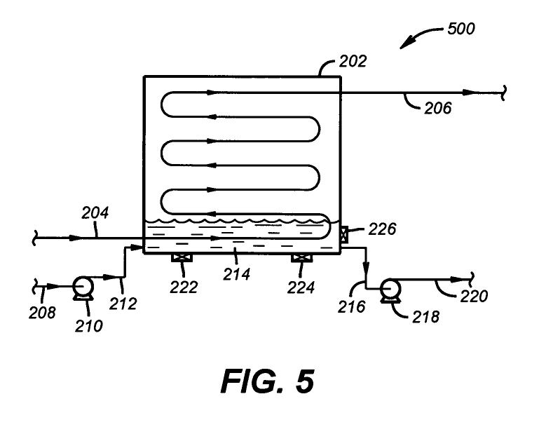

FIG. 5 illustrates another embodiment of the invention 500, including a pasteurization unit 202, inlet conduit 204 for biosolids, and an exit conduit 206 for heated biosolids. In the embodiment illustrated in FIG. 5, a supply of liquid heat transfer fluid is supplied in a sump 214 by conduit 208, transfer means 210, and conduit 212. Conduits 216 and 220, and transfer means 218 are provided for removal of heat transfer fluid. Drain plugs 222, 224, and 226 are preferably provided. In this embodiment, biosolids are first indirectly contacted with liquid heat transfer fluid, and then indirectly with air or other gaseous atmosphere in the enclosed space of pasteurization unit 202.

Pasteurization units 40, 60, 101, and 202 of the systems of the invention, as illustrated in FIGS. 2, 3, 4, and 5 respectively, preferably comprise a metal box which is insulated so as to reduce heat loss from the pasteurization unit. While this has the effect of increasing the size of the pasteurization units of the invention, the reduction in heat loss more than makes up for an increase in size. Insulation is preferred but not necessary. For example, in warm climates no insulation may be required.

In operation of the inventive pasteurization systems, there will preferably be associated with the flow of biosolids a temperature probe on the exit conduit. For example, a thermowell preferably provides a mechanism for introducing a means for measuring temperature of biosolids in conduit 18 in FIG. 2, and an associated temperature controller is preferably provided to control the operation of transfer means 46 and 54, and/or transfer means 8. In FIG. 3 a similar temperature control scheme preferably controls transfer means 74, transfer means 78, and/or the inlet biosolids flow through conduit 68. Any combination of these temperature controls would be sufficient. The lowest cost yet reliable method is preferred.

Although the above description of preferred processes and apparatus of the invention are representative of the invention, they are by no means intended to limit the appended claims.

1. A pasteurization system, comprising:
a) an enclosure defining a heating chamber;
b) a liquid flow conduit positioned within the heating chamber, the conduit having an inlet and an outlet and defining a flow path for a slurry to be pasteurized from said inlet toward said outlet at a predetermined rate for establishing a minimum period of residence time of the slurry within said flow conduit sufficient to kill all pathogens in said slurry while the slurry is heated from ambient temperature to a predetermined minimum temperature of between about 145 and 160 degrees F. while the slurry traverses the conduit; and
c) means for heating, via indirect contact heat transfer, the slurry from ambient temperature to said minimum temperature after said slurry is introduced into said flow conduit, said means for heating positioned inside the heating chamber.

2. The system of claim 1 wherein the means for heating comprises at least one header having a plurality of means for emitting a heat transfer fluid into the heating chamber and to contact the heat transfer fluid with the conduit in a plurality of locations.

3. The system of claim 2 wherein said conduit is comprises a serpentine conduit comprising a plurality of substantially parallel pathways in the heating chamber.

4. The system of claim 2 wherein said heat transfer fluid is selected from the group consisting of water, steam, or combinations thereof.

5. The system of claim 4 wherein said heat transfer fluid is water adapted to have a temperature exiting the header ranging from about 170 F to about 212 F.

6. The system of claim 5 including an inlet water transfer means and an exit water transfer means.

7. The system of claim 1 wherein the heat transfer fluid is a liquid, and the enclosure comprises a sump for spent heat transfer liquid, wherein the system comprises inlet transfer means adapted to deliver said heat transfer fluid and exit transfer means adapted to remove said spent heat transfer fluid.

8. The system of claim 3 wherein at least a first leg of the serpentine conduit is adapted to traverse through spent heat transfer fluid collected in a sump, the sump comprising a lower portion of the enclosure.

9. The system of claim 1 wherein the liquid flow conduit comprises a plurality of conduits, each of the plurality of conduits attached at a first end to an inlet header and at a second end to an exit header.

10. The system of claim 9 wherein the enclosure includes a sump comprising a non-horizontal bottom.

11. The system of claim 1 further comprising one or more a fuel burners.

12. The system of claim 10 further comprising one or more a fuel burners.

13. A pasteurization process comprising:
a) providing an enclosure defining a heating chamber, and providing a flow conduit positioned in the heating chamber, the flow conduit having an inlet and an outlet;
b) introducing a flow of a liquid slurry into said conduit at said inlet;
c) introducing into the heating chamber a heat transfer fluid at a first temperature, said first temperature being not less than 160 F;
d) heating said slurry via indirect contact heat transfer from ambient temperature to a predetermined minimum temperature of from about 145 F to about 160 F via indirect contact with said heat transfer fluid while said slurry traverses through the conduit; and
e) maintaining said flow of slurry in said conduit at said predetermined temperature for a minimum period of about thirty minutes sufficient to kill substantially all pathogens in said slurry while maintaining a flow of said slurry from said outlet.

14. The process of claim 13 wherein said step of introducing a heat transfer fluid comprises transferring a heat transfer fluid into and out of a sump.

15. The process of claim 13 wherein said step of introducing a heat transfer fluid comprises providing one or more heat transfer fluid headers in said heating chamber, said headers having a plurality of means for dispensing said heat transfer fluid in said heating chamber.

16. The process of claim 13 including introducing heated combustion effluent gases into said heating chamber via combustion of a fuel in one or more combustion burners attached to said enclosure.
